(19) United States
(12) Patent Application Publication
(10) Pub. No.: US 2024/0258595 A1
(43) Pub. Date: Aug. 1, 2024

(54) FREE-STANDING ELECTRODE FILM CONTAINING RECYCLED MATERIALS

(71) Applicant: LiCAP Technologies, Inc., Sacramento, CA (US)

(72) Inventors: Linda Zhong, Sacramento, CA (US); Bibek Tiwari, Sacramento, CA (US); Erika Shaw, Sacramento, CA (US); Martin Zea, Sacramento, CA (US)

(21) Appl. No.: 18/103,126

(22) Filed: Jan. 30, 2023

(51) Int. Cl. H01M 10/54; H01M 4/04; H01M 4/38; H01M 4/485; H01M 4/62

(52) U.S. Cl. CPC H01M 10/54; H01M 4/043; H01M 4/386; H01M 4/485; H01M 4/62

(57) ABSTRACT

A method of manufacturing a free-standing electrode film for an energy storage device includes preparing a first mixture including at least one electrode active material and at least one fibrillizable binder, the first mixture having total solid contents greater than 95% by weight, fibrillizing the at least one fibrillizable binder in the first mixture by subjecting the first mixture to a shear force, pressing the first mixture into a first free-standing electrode film, shredding at least a portion of the first free-standing electrode film, preparing a second mixture including the shredded at least a portion of the first free-standing electrode film, subjecting the second mixture to a shear force, and pressing the second mixture into a second free-standing electrode film. The first mixture may include at least a portion of a previously manufactured free-standing electrode film.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to manufacturing energy storage devices such as Li-ion batteries, solid state batteries, Li-ion capacitors (LIC), and ultracapacitors and, more particularly, to dry processes for the manufacture of electrodes for energy storage devices.

### 2. Related Art

As demand for inexpensive energy storage devices increases, various methods have been proposed for manufacturing electrodes. Among these, there exist so-called “dry” processes by which a free-standing electrode film may be manufactured while avoiding the expense and drying time associated with the solvents and aqueous solutions that are typically used in slurry coating and extrusion processes. After a free-standing electrode film is produced, it is laminated to a current collector in order to produce an electrode. When aligning the electrode film with the current collector for lamination, the film may need to be trimmed and the trimmings may typically be discarded. In addition, a portion of the electrode films that are produced may not meet the specifications for the desired energy storage device and may be wholly discarded. The resulting electrode film trimmings and out-of-spec electrode films may represent waste, reducing the yield of the manufacturing process. While efforts may be made to increase the efficiency of a manufacturing process so as to produce less waste, even a small amount of waste may reduce the economic feasibility of the process, which may be especially significant if the process is to be used for the mass production of energy storage devices. The situation will only get worse given the increasing prices of raw active materials.

### BRIEF SUMMARY

The present disclosure contemplates various systems and methods, as well as related products, for overcoming the above drawbacks accompanying the related art. One aspect of the embodiments of the present disclosure is a method of manufacturing a free-standing electrode film for an energy storage device. The method may comprise preparing a first mixture including at least one electrode active material and at least one fibrillizable binder, the first mixture having total solid contents greater than 95% by weight. The method may further comprise fibrillizing the at least one fibrillizable binder in the first mixture by subjecting the first mixture to a shear force and pressing the first mixture into a first free-standing electrode film. The method may further comprise shredding at least a portion of the first free-standing electrode film (e.g., to serve as recycled material in a subsequent film) and preparing a second mixture including at least one electrode active material, at least one fibrillizable binder, and the shredded at least a portion of the first free-standing electrode film. The method may further comprise fibrillizing the at least one fibrillizable binder in the second mixture by subjecting the second mixture to a shear force and pressing the second mixture into a second free-standing electrode film. The second free-standing electrode film may thus include, as recycled material, at least a portion of the first free-standing electrode film.

The first mixture may include at least a portion of a previously manufactured free-standing electrode film. By the same token, a portion of the second free-standing electrode film may be recycled for use in a subsequent mixture to produce a subsequent free-standing electrode film. In this way, the manufacturing process, whether it is a batch process or a continuous process, may incorporate recycled material in each successive electrode film that is produced.

The preparing of the second (and/or first) mixture may include mixing the second (and/or first) mixture. The subjecting of the second (and/or first) mixture to the shear force may include mixing the second (and/or first) mixture with a shear force greater than during the preparing of the mixture.

The at least one electrode active material of the first mixture and/or the at least one active material of the second mixture may comprise one or more electrode active materials selected from the group consisting of lithium metal oxides, such as lithium nickel cobalt manganese oxide (NCM), lithium iron phosphate (LFP), lithium nickel cobalt aluminum oxide (NCA), lithium manganese nickel oxide (LMNO), lithium manganese iron phosphate (LMFP), lithium manganese oxide (LMO), and lithium cobalt oxide (LCO), carbon-based materials, such as graphite, activated carbon, hard carbon, and soft carbon, titanium dioxide, and silicon-based materials. Either or both of the first and second mixtures may include a conductive material, a solvent, a paste, a slurry, a polymer additive, a polymer additive in a liquid carrier, and/or a solid electrolyte powder. The solvent may have a boiling point of less than 180° C.

The shredded at least a portion of the first free-standing electrode film may constitute 0.1% to 5%, 5% to 25%, 25% to 50%, 50% to 75%, 75% to 95%, or greater than 95% of the second mixture.

Another aspect of the embodiments of the present disclosure is a method of manufacturing a free-standing electrode film for an energy storage device. The method may comprise preparing a first mixture including at least one electrode active material and at least one fibrillizable binder, the first mixture having total solid contents greater than 95% by weight, fibrillizing the at least one fibrillizable binder in the first mixture by subjecting the first mixture to a shear force, pressing the first mixture into a first free-standing electrode film, shredding at least a portion of the first free-standing electrode film, preparing a second mixture including the shredded at least a portion of the first free-standing electrode film, subjecting the second mixture to a shear force, and pressing the second mixture into a second free-standing electrode film.

The first mixture may include at least a portion of a previously manufactured free-standing electrode film. A portion of the second free-standing electrode film may be recycled for use in a subsequent mixture to produce a subsequent free-standing electrode film.

The preparing of the second (and/or first) mixture may include mixing the second (and/or first) mixture. The subjecting of the second (and/or first) mixture to the shear force may include mixing the second (and/or first) mixture with a shear force greater than during the preparing of the mixture.

The at least one electrode active material of the first mixture and/or the at least one active material of the second mixture may comprise one or more electrode active materials selected from the group consisting of lithium metal oxides, such as lithium nickel cobalt manganese oxide (NCM), lithium iron phosphate (LFP), lithium nickel cobalt aluminum oxide (NCA), lithium manganese nickel oxide (LMNO), lithium manganese iron phosphate (LMFP), lithium manganese oxide (LMO), and lithium cobalt oxide (LCO), carbon-based materials, such as graphite, activated carbon, hard carbon, and soft carbon, titanium dioxide, and silicon-based materials. Either or both of the first and second mixtures may include a conductive material, a solvent, a paste, a slurry, a polymer additive, a polymer additive in a liquid carrier, and/or a solid electrolyte powder.

The shredded at least a portion of the first free-standing electrode film may constitute 0.1% to 5%, 5% to 25%, 25% to 50%, 50% to 75%, 75% to 95%, or greater than 95% of the second mixture. The shredded at least a portion of the first free-standing electrode film may be 100% of the second mixture. The shredded at least a portion of the first free-standing electrode film may contain the only electrode active material that is included in the second mixture.

Another aspect of the embodiments of the present disclosure is a method of manufacturing an energy storage device. The method may comprise, in addition to either of the above methods of manufacturing a free-standing electrode film, laminating the second free-standing electrode film on a current collector. (In a case where the first free-standing electrode film is within specifications and is merely trimmed to produce the recycled material, the first free-standing electrode film may likewise be laminated on a current collector for the manufacture of an energy storage device.)

Another aspect of the embodiments of the present disclosure is a free-standing electrode film for an energy storage device. The free-standing electrode film may comprise at least one electrode active material and at least one fibrillizable binder, wherein at least a portion of the at least one electrode active material and at least a portion of the at least one fibrillizable binder are recycled from a shredded electrode film.

Total binder content of the free-standing electrode film may be less than 8%, less than 4%, less than 3%, or less than 2% by weight of the free-standing electrode film.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a system for manufacturing an electrode for an energy storage device according to an embodiment of the present disclosure; and

FIG. 2 shows an operational flow for manufacturing an electrode for an energy storage device according to an embodiment of the present disclosure.

### DETAILED DESCRIPTION

The present disclosure encompasses various embodiments of systems for manufacturing electrodes for energy storage devices as well as manufacturing methods and intermediate and final products thereof. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

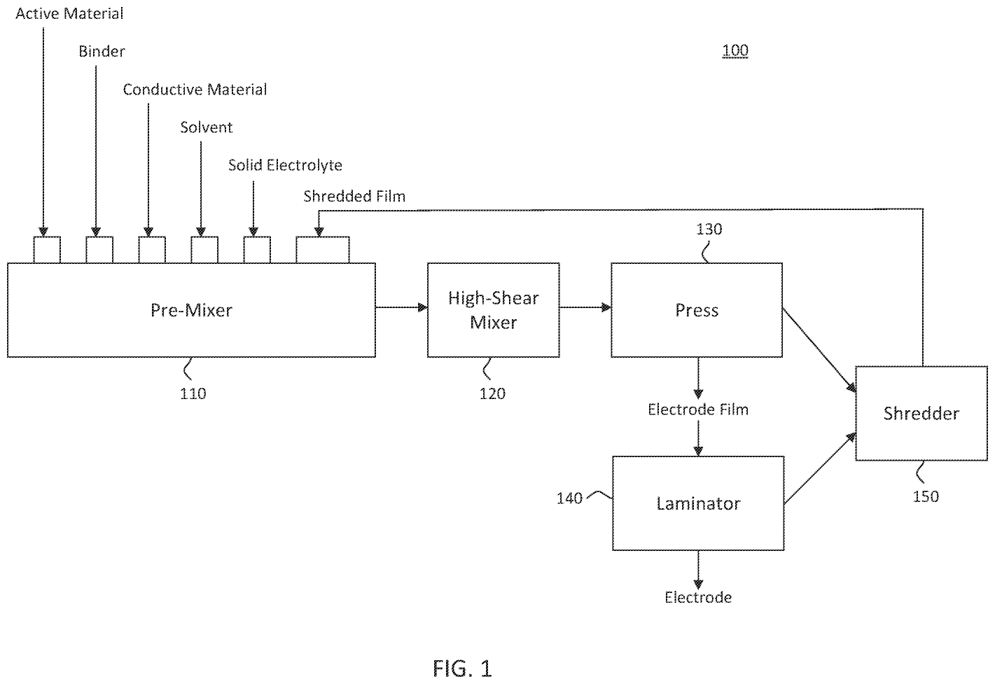

FIG. 1 shows a system 100 for manufacturing an electrode for an energy storage device such as a Li-ion battery, solid state battery, Li-ion capacitor (LIC), or ultracapacitor. The finished energy storage device may comprise one or more electrodes made according to the disclosed methods, where each electrode may be assembled by laminating one or more free-standing electrode films on a current collector such as an aluminum metal sheet in the case of a cathode electrode or a copper metal sheet in the case of anode electrode. As schematically illustrated in FIG. 1, the system 100 may generally comprise a pre-mixer 110 for preparing a dry mixture of ingredients for the electrode film to be produced, a high-shear mixer 120 for subjecting the mixture to a shear force, a press 130 for pressing the dry mixture into a free-standing electrode film, and a laminator 140 for laminating the free-standing electrode film onto a current collector, thus producing an electrode. Unlike conventional systems, the exemplary system 100 shown in FIG. 1 provides for the recycling of any unused portions of electrode film output by the press 130 or laminator 140, such as out-of-spec electrode films produced from the dry mixture or electrode film trimmings that might be removed from otherwise usable electrode films as part of the lamination process. Such unused portions of electrode film may be shredded by a shredder 150 as schematically illustrated in FIG. 1 and fed back to the pre-mixer 110 to be incorporated into the dry mixture that will be used to produce a subsequent electrode film. In this way, a continuous or batch manufacturing process may be implemented that effectively eliminates electrode film waste while at the same time relaxing process efficiency considerations. As described herein, it has been found that the use of recycled electrode film material in accordance with the disclosed techniques does not adversely affect the properties of the resulting electrodes or energy storage devices, making the disclosed innovations highly advantageous for mass production of energy storage devices.

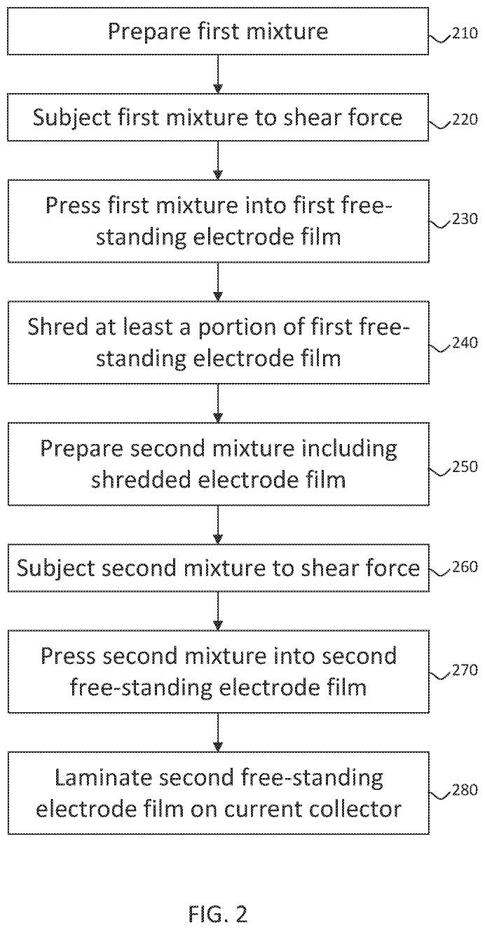

Referring additionally to FIG. 2, an exemplary operational flow for manufacturing an electrode using the system 100 may begin with preparing a first mixture including at least one electrode active material and at least one fibrillizable binder (step 210). The electrode active material(s) may depend on the particular energy storage device to be made and may include, for example, lithium nickel cobalt manganese oxide (NCM), lithium iron phosphate (LFP), lithium nickel cobalt aluminum oxide (NCA), lithium manganese nickel oxide (LMNO), lithium manganese iron phosphate (LMFP), lithium manganese oxide (LMO), lithium cobalt oxide (LCO), graphite, activated carbon, hard carbon, soft carbon, titanium dioxide, and/or silicon. The at least one fibrillizable binder may comprise a thermoplastic binder that is able to stretch and become longer and finer without breaking upon application of a shear force, such as polytetrafluoroethylene (PTFE), for example. Additional binders (fibrillizable or otherwise) may be included in the first mixture as well, and the at least one fibrillizable binder may be a component of a composite binder such as those disclosed in U.S. Patent Application Pub. No. 2022/0158150, entitled “Dry Electrode Manufacture with Composite Binder,” the entire contents of which is incorporated by reference herein. Total binder content in the first mixture may be less than 8%, preferably less than 4%, and more preferably less than 3% or less than 2%.

The first mixture may further include a conductive material such as activated carbon, a conductive carbon black such as acetylene black, Ketjen black, or super P (e.g., a carbon black sold under the trade name SUPER P® by Imerys Graphite & Carbon of Switzerland), carbon nanotubes (CNT), graphite particles, graphene, a conducting polymer, and combinations thereof. The conductive material may be an element of a conductive paste comprising a polymer additive mixed with a liquid carrier as described in U.S. Pat. No. 11,508,956 (“the '956 patent”), entitled “Dry Electrode Manufacture with Lubricated Active Material Mixture,” the entire contents of which is incorporated by reference herein. While not separately depicted in FIG. 2 of the present disclosure, an additive solution as contemplated by the '956 patent, which may comprise a polymer additive mixed with a liquid carrier without necessarily including the conductive material, may also be added to first mixture described herein.

In order to chemically activate the at least one fibrillizable binder to improve its adhesion strength (e.g., allowing it to soften further and become more able to stretch without breaking), a highly vaporizable solvent may also be included in the first mixture as described in U.S. Pat. No. 9,236,599, entitled “Low Cost High Performance Electrode for Energy Storage Devices and Systems and Method of Making Same,” and U.S. Pat. No. 10,069,131, entitled “Electrode for Energy Storage Devices and Method of Making Same,” the entire contents of each of which is incorporated by reference herein. The solvent may have a relatively low boiling point of less than 180° C., less than 130° C., or less than 100° C. such that minimal or no drying process is necessary to remove the solvent afterwards (unlike slurry-based and extrusion processes for producing electrodes). Example solvents may include hydrocarbons (e.g., hexane, benzene, toluene), acetates (e.g., methyl acetate, ethyl acetate), alcohols (e.g., propanol, methanol, ethanol, isopropyl alcohol, butanol), glycols, acetone, dimethyl carbonate (DMC), diethyl carbonate (DEC), and tetrachloroethylene. Unlike in the case of slurry-based and extrusion methods, the amount of the solvent may generally be very low, with the first mixture having total solid contents greater than 95% by weight, for example.

In the case of manufacturing an electrode for a solid-state battery, it is contemplated that the first mixture may include a solid electrolyte powder. The solid electrolyte powder may be a dry electrolyte powder as described in Applicant's co-pending U.S. patent application Ser. Nos. 17/942,458 and 17/942,579, entitled “Dry Electrode Manufacture for Solid State Energy Storage Devices,” the entire contents of each of which is incorporated by reference herein, and may be primarily (e.g., 80-100% by weight) a ceramic such as a garnet-structure oxide, for example, lithium lanthanum zirconium oxide (LLZO) with various dopants (e.g., Li_{6.5}La₃Zr₂O₁₂ or Li₇La₃Zr₂O₁₂), lithium lanthanum zirconium tantalum oxide (LLZTO) (e.g., Li_{6.4}La₃Z_{1.4}Ta_{0.6}O₁₂), lithium lanthanum zirconium niobium oxide (LLZNbO) (e.g., Li_{6.5}La₃Zr_{1.5}Nb_{0.5}O₁₂), lithium lanthanum zirconium tungsten oxide (LLZWO) (e.g., Li_{6.3}La₃Zr_{1.65}W_{0.35}O₁₂), a perovskite-structure oxide, for example, lithium lanthanum titanate (LLTO) (e.g., Li_{0.5}La_{0.5}TiO₃, Li_{0.34}La_{0.56}TiO₃, or Li_{0.29}La_{0.57}TiO₃) or lithium aluminum titanium phosphate (LATP) (e.g., Li_{1.4}Al_{0.4}Ti_{1.6}(PO₄)₃), a lithium super ionic conductor Li₂₊₂ₓZn₁₋ₓGeO₄ (LISICON), for example, lithium aluminum titanium phosphate (LATP) (e.g., Li_{1.3}Al_{0.3}Ti_{1.7}(PO₄)₃), lithium aluminum germanium phosphate (LAG or sodium super ionic conductor, i.e., NASICON-type LAGP) (e.g., Li_{1.5}Al_{0.5}Ge_{1.5}(PO₄)₃ or Li_{1.5}Al_{0.5}Ge_{1.5}P₃O₁₂), or a phosphate, for example, lithium titanium phosphate (LTPO) (e.g., LiTi₂(PO₄)₃), lithium germanium phosphate (LGPO) (e.g., LiGe₂(PO₄)₃), lithium phosphate (LPO) (e.g., gamma-Li₃PO₄ or LizP₃O₁₁), or lithium phosphorus oxynitride (LiPON). As another example, the solid electrolyte powder may be primarily (e.g., 80-100% by weight) a polymer such as PEO, PEO-PTFE, PEO-LiTFSi, PEO-LiTFSI/LLZO, PEO-LiClO₄, PEO-LiClO₄/LLZO, poly(3,4-cthylenedioxythiophenc) polystyrene sulfonate (PEDOT:PSS), polyphenylene oxide (PPO), polyethylene glycol (PEG), a polyether-based polymer, a polyester-based polymer, a nitril-based polymer, a polysiloxane-based polymer, polyurethane, poly-(bis((methoxyethoxy)ethoxy)phosphazene) (MEEP), or polyvinyl alcohol (PVA). As another example, the solid electrolyte powder may be primarily (e.g., 80-100% by weight) a sulfide such as lithium sulfide (LS) (e.g., LizS), glassy lithium sulfide phosphorus sulfide (LSPS) (e.g., LizS-P₂S₅), glassy lithium sulfide boron sulfide (LSBS) (e.g., LizS-B₂S₃), glassy lithium sulfide silicon sulfide (LSSiS) (e.g., Li₂S-SiS₂), lithium germanium sulfide (LGS) (e.g., Li₄GeS₄), lithium phosphorus sulfide (LPS) (e.g., Li₃PS₄ such as 75Li₂S-25P₂S₅ or LizP₃S₁₁ such as 70Li₂S-30P₂S₅), lithium silicon phosphorus tin sulfide (LSPTS) (e.g., Lix(SiSn)PySz), argyridite Li₆PS₅X (X═Cl. Br) (e.g., LPSBr such as Li₆PS₅Br, LPSCl such as Li₆PS₅Cl, LPSClBr such as Li₆PS₅Cl_{0.5}Br_{0.5}, or LSiPSCl such as Li_{9.54}Si_{1.74}P_{1.44}S_{11.7}Cl_{0.3}), or thio-LISICON (e.g., LGPS such as Li₁₀GePS₁₂).

Because of the cyclical nature of the recycling process enabled by the system 100, the first mixture contemplated in step 210 of FIG. 2 need not necessarily represent an initial batch or an initial run of a continuous process. Rather, the first mixture may represent a mixture that is prepared at any stage of an ongoing process. As such, the first mixture may itself include at least a portion of a previously manufactured free-standing electrode film (indicated as “shredded film” in FIG. 1) as described in more detail below.

The operational flow of FIG. 2 may continue with subjecting the first mixture to a shear force (step 220). Whereas the pre-mixer 110 for preparing the first mixture in step 210 may broadly contemplate any kind of equipment for combining the ingredients together such as a hand mixer, a V blender, or a cone blender, the mixer 120 for applying the shear force may advantageously be a high-shear mixer such as a kitchen blender, an industrial blender, a jet mill, or a multiple roll mill (e.g., a two-roll mill, a three-roll mill, etc.) in order to apply enough shear force to fibrillize the fibrillizable binder. In this regard, it is contemplated that the preparing of the first mixture may include mixing the first mixture and that the subjecting of the first mixture to the shear force may include mixing the first mixture with a shear force greater than during the preparing of the first mixture. Mixing as part of preparing the mixture may cause less fibrillization than the high-shear mixing and may preferably cause substantially no fibrillization. It should be noted that the pre-mixer 110 and high-shear mixer 120 may in some cases be the same appliance, such as where the same mixer is first operated with one setting (e.g., one speed setting) and then operated with another. It is also contemplated that steps 210 and 220 may overlap to some degree, with the first mixture being completed after some of the ingredients of the first mixture have already begun to be subjected to the shear force. For example, the solvent and/or fibrillizable binder may be injected into the high-shear mixer 120 or otherwise added (or supplemented) once high-shear mixing has already begun.

Once the fibrillizable binder is sufficiently fibrillized, which may help to ensure that the first mixture is able to adequately stretch without breaking, the operational flow of FIG. 2 may continue with pressing the first mixture into a first free-standing electrode film (step 230). The press 130 may be a roller press and may typically include working rolls arranged horizontally so that the film may emerge from the bottom thereof as it is produced from a powder mixture that is poured on top. Thermal activation of the fibrillizable binder may also be performed on the press 130 (which may be heated) or at an earlier time in the process as described in U.S. Patent Application Pub. No. 2020/0388822, entitled “Dry Electrode Manufacture by Temperature Activation Method,” the entire contents of which is incorporated by reference herein. The press 130 may be one component of a mill line that may further include one or more thickness-reducing presses that may typically include working rolls arranged vertically. The press 130 may feed finished film to the laminator 140. An example of the press 130 and laminator 140 is the apparatus described in Applicant's U.S. patent application Ser. No. 17/835,205, entitled “Free-Standing Electrode Film for Dry Electrode Manufacture,” the entire contents of which is incorporated by reference herein.

In the context of the operational flow of FIG. 2, which may illustrate one example iteration of a cyclical recycling process, the first free-standing electrode film refers to a film that will be wholly or partly unusable in an energy storage device and will thus be recycled (wholly or partially) into a subsequent second mixture for the production of a second free-standing electrode film. In this regard, the operational flow may continue with shredding at least a portion of the first free-standing electrode film (step 240). An example of the first free-standing electrode film being wholly unusable is where it is an out-of-spec film that is a waste output of the press 130. An example of the first free-standing electrode film being partly unusable is where a portion of the film is trimmed during the lamination process or during thickness reduction, in which case the unused strips, edges, or other trimmed portion may be a waste output of the laminator 140 or the press 130. The shredding of such unused film or film trimming may be done by the shredder 150 shown in FIG. 1, which may be any type of shredder or combination of shredders, such as paper shredders, grass choppers, fitz mills, horizontal hammermills, vertical hammermills, slow-speed shear shredders, granulators, knife hogs, raspers, maulers, flails, cracker mills, refining mills, etc. The recycled material output from such shredding (indicated in FIG. 1 as “shredded film”) may then be fed back to the pre-mixer 110 to be incorporated into a subsequent dry mixture for the production of a subsequent free-standing electrode film. Thus, the operational flow of FIG. 2 may continue with preparing a second mixture including the shredded electrode film (step 250), subjecting the second mixture to a shear force (step 260), pressing the second mixture into a second free-standing electrode film (step 270), and laminating the second free-standing electrode film onto a current collector (step 280). Steps 250-270 may be the same as steps 210-230, described above. While not separately depicted in FIG. 2, it is noted that step 280 of laminating the second free-standing electrode film onto a current collector (thus producing an electrode) may also be performed on the first electrode film assuming that the first electrode film is a usable film (such as where only a trimmed portion is recycled). As in the case of the first mixture, total binder content in the second mixture (and likewise in either of the free-standing films produced from the mixtures) may be less than 8%, preferably less than 4%, and more preferably less than 3% or less than 2%.

As noted above, it has been found that the use of recycled electrode film material in accordance with the disclosed techniques does not adversely affect the properties of the resulting electrodes or energy storage devices. The following Table 1 shows exemplary data of electrochemical performance of NCM electrodes made with recycled electrode film according to the above processes.

TABLE 1

| | Areal | | | | | | | |
|---|---|---|---|---|---|---|---|---|
| Pristine/ | Capacity | Film | Formation Cycle | | | 2nd Cycle | | |
| Recycled | Loading | Dens. | Charge | Disch. | Effic. | Charge | Disch. | Effic. |
| (mass %) | (mAh/cm²) | (g/cc) | (mAh/g) | (mAh/g) | (%) | (mAh/g) | (mAh/g) | (%) |
| 100%/0% | 4.06 | 3.24 | 225.4 | 212.4 | 94% | 215.3 | 212.7 | 99% |
| 75%/25% | 4.1 | 3.38 | 224.1 | 211.5 | 94% | 214.8 | 212.1 | 99% |
| 50%/50% | 4.27 | 3.52 | 223.1 | 211.7 | 95% | 214.5 | 212.4 | 99% |
| 25%/75% | 4.43 | 3.61 | 224.5 | 212.4 | 95% | 216 | 212.9 | 99% |

As can be seen, regardless of the relative percentages of pristine materials vs. recycled materials, discharge capacity and efficiency remain consistent. While not reflected in Table 1, it has also been found that the discharge capacity and efficiency remain consistent in the case of 0% pristine/100% recycled material, and that the same is true for C-rates 0.1, 0.2, 0.5, 1, 2, 3, and 4. It is thus contemplated that high power density can be maintained irrespective of the amount of recycled film material used in the manufacturing process, making the technology suitable for cathodes of fast charging electric vehicle batteries. The recycled film may simply be shredded and added to a subsequent mixture directly without requiring any other adjustment to the formulation or to the manufacturing process. It is contemplated, however, that slight adjustments to the formulations or process may be made for close property matching.

As an exemplary anode material, the following Tables 2.1 and 2.2 similarly show averaged data of electrochemical performance of graphite electrodes made with recycled electrode film according to the above processes.

TABLE 2.1

| Pristine/ | SS Film | | | | |
|---|---|---|---|---|---|
| Recycled | Thickness | Density | Porosity | Loading | IR |
| (mass %) | (μm) | (g/cc) | (%) | (mAh/cm²) | (ohm) |
| 100%/0% | 88.3 | 1.59 | 29.0% | 9.2 | 4.633 |
| | | | | (4.6/side) | |
| 80%/20% | 89.2 | 1.55 | 30.9% | 9.0 | 3.673 |
| | | | | (4.5/side) | |
| 50%/50% | 95.0 | 1.62 | 27.7% | 10.1 | 6.987 |
| | | | | (5.0/side) | |

TABLE 2.2

| | 1st Cycle (0.1 C) | | | 2nd Cycle (0.1 C) | | |
|---|---|---|---|---|---|---|
| Pristine/ | Charge | Disch. | | Charge | Disch. | |
| Recycled | (mAh/ | (mAh/ | Effic. | (mAh/ | (mAh/ | Effic. |
| (mass %) | g) | g) | (%) | g) | g) | (%) |
| 100%/0% | 373.9 | 343.9 | 92.0% | 346.1 | 343.0 | 99.1% |
| 80%/20% | 377.4 | 340.8 | 90.3% | 345.3 | 341.6 | 98.9% |
| 50%/50% | 379.2 | 340.2 | 89.7% | 345.9 | 342.3 | 98.9% |

Again, regardless of the relative percentages of pristine materials vs. recycled materials, discharge capacity and efficiency remain consistent, at least by the second cycle. While not reflected in Tables 2.1 and 2.2, it has also been found that the discharge capacity and efficiency remain consistent in the case of higher percentages of recycled material up to and including 0% pristine/100% recycled material. In this case as well, the recycled film may simply be shredded and added to a subsequent mixture directly without requiring any other adjustment to the formulation or to the manufacturing process. It is contemplated, however, that slight adjustments to the formulations or process may be made for close property matching.

The following Tables 3.1, 3.2, and 3.3 similarly show averaged data of electrochemical performance of a full cell including an NCM cathode and a graphite anode, both made with recycled electrode film according to the above processes.

TABLE 3.1

| | Cathode | Cathode | Cathode | Cathode | Cathode |
|---|---|---|---|---|---|
| Pristine/ | Film | Film | Film | Film | Film |
| Recycled | Thickness | Density | Porosity | Loading | Loading |
| (mass %) | (μm) | (g/cc) | (%) | (mg/cm²) | (mAh/cm²) |
| 100%/0% | 87.2 | 2.6 | 44.4% | 20.9 | 4.46 |
| 75%/25% | 87.4 | 2.5 | 45.3% | 20.6 | 4.39 |
| 50%/50% | 90.0 | 2.5 | 45.7% | 21.1 | 4.49 |

TABLE 3.2

| | Anode | | | Anode | Anode | |
|---|---|---|---|---|---|---|
| | Film | Anode | Anode | Film | Film | |
| Pristine/ | Thick- | Film | Film | Loading | Loading | |
| Recycled | ness | Density | Porosity | (mg/ | (mAh/ | IR |
| (mass %) | (μm) | (g/cc) | (%) | cm²) | cm²) | (ohm) |
| 100%/0% | 99.0 | 1.6 | 30.4% | 14.8 | 5.04 | 0.53 |
| 75%/25% | 99.1 | 1.5 | 31.5% | 14.6 | 4.96 | 0.50 |
| 50%/50% | 98.3 | 1.6 | 29.0% | 15.0 | 5.1 | 0.52 |

TABLE 3.3

| Pristine/ | Formation Cycle | | | 1st Cycle | | 2nd Cycle | |
|---|---|---|---|---|---|---|---|
| Recycled | Charge | Discharge | Effic. | Discharge | Effic. | Discharge | Effic. |
| (mass %) | (mAh/g) | (mAh/g) | (%) | (mAh/g) | (%) | (mAh/g) | (%) |
| 100%/0% | 223.91 | 184.34 | 82.3% | 185.4 | 97.8% | 184.3 | 99.0% |
| 75%/25% | 224.97 | 184.60 | 82.1% | 184.5 | 97.6% | 183.4 | 99.0% |
| 50%/50% | 224.2 | 181.8 | 81.1% | 184.31 | 97.4% | 183.4 | 98.9% |

Again, as can be seen, regardless of the relative percentages of pristine materials vs. recycled materials, discharge capacity and efficiency remain consistent, at least by the second cycle. While not reflected in Tables 3.1, 3.2, and 3.3, it has also been found that the discharge capacity and efficiency remain consistent in the case of higher percentages of recycled material up to and including 0% pristine/100% recycled material and that the same is true for C-rates 0.1, 0.2, 0.5, 1.0, and 2.0 and that discharge capacity retention remains consistent for at least 100 cycles. It is thus contemplated that high power density can be maintained irrespective of the amount of recycled film material used in the manufacturing process, making the technology suitable for both cathodes and anodes of fast charging electric vehicle batteries.

In general, the percentage of recycled material used may depend on the efficiency of the manufacturing process, the available materials, and the needs and aims of consumers and manufacturers. Since it has been found that there is no degradation in the quality of the resulting electrode films or of the resulting electrodes, any and all percentages of recycled materials are contemplated within the scope of the present disclosure. For example, in the case of a highly efficient manufacturing process that produces little waste, shredded film may constitute only 0.1% to 5% by weight of the mixture used to produce the next electrode film. In less efficient processes, or when a large quantity of discarded electron films are available (e.g., the waste of a manufacturing process that did not use any recycling), higher percentages of shredded film may be used, for example, 5% to 25%, 25% to 50%, 50% to 75%, 75% to 95%, or greater than 95% (including 100% recycled material in some cases). It is also contemplated that consumers (e.g., electric vehicle manufacturers) may prefer buying a product that contains recycled material in order to demonstrate their commitment to reducing waste for the benefit of the environment. In this case, electrodes containing electrode films that are made from “greater than 50% recycled material” or “100% recycled material” may be desired.

It is noted that the recycled film itself, technically speaking, includes the materials used to produce another electrode film, such that the addition of other materials besides the recycled film (e.g., electrode active material, binder, conductive material, solvent, and/or solid electrolyte as shown in FIG. 1) may be considered optional. In this regard, it is contemplated that any of the mixtures described herein may be made of 100% recycled film. The fibrillizable binder contained within such shredded film material may be re-fibrillized by the application of shear force (e.g., by the high-shear mixer 120) after having been shredded by the shredder 150. The re-fibrillized binder may effectively bind together both the electrode active material that is already contained in the recycled film and any new electrode active material (and other ingredients) that may be added to the mixture. Thus, the use of recycled film may reduce the amount of binder that is needed for a mixture as the recycled film itself adds binder to the mixture. On the other hand, it has been found in some cases that the recycled film portion (whether or not it constitutes 100% of the mixture) may itself benefit from the addition of supplemental fibrillizable binder or solvent as described above. In particular, especially in the case of producing an activated carbon electrode film for a capacitor (more so than for an NCM battery electrode, for example), supplementing the recycled portion with fibrillizable binder and/or solvent may improve the consistency of the resulting electrode film.

In the above examples, it is described that the recycled film portion of a given dry mixture may be produced by shredding out-of-spec electrode films and/or electrode film trimmings. However, the use of recycled materials is not necessarily limited to these examples of recycled film. Other collected recycled material that may be added to the mixture may include, for example, dry powdery material from dust collectors, which may accumulate at any stage in the manufacturing process. It is contemplated that any and all such recyclable materials may be fed back into the manufacturing process, reducing waste and yield loss potentially to 0% (as compared to about 10% yield loss in a typical slurry-based or extrusion process or even greater yield loss in the case of a typical dry process that does not make use of recycled materials).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of manufacturing a free-standing electrode film for an energy storage device, the method comprising:
preparing a first mixture including at least one electrode active material and at least one fibrillizable binder, the first mixture having total solid contents greater than 95% by weight;
fibrillizing the at least one fibrillizable binder in the first mixture by subjecting the first mixture to a shear force;
pressing the first mixture into a first free-standing electrode film;
shredding at least a portion of the first free-standing electrode film;
preparing a second mixture including at least one electrode active material, at least one fibrillizable binder, and the shredded at least a portion of the first free-standing electrode film;
fibrillizing the at least one fibrillizable binder in the second mixture by subjecting the second mixture to a shear force; and
pressing the second mixture into a second free-standing electrode film.

2. The method of claim 1, wherein the first mixture includes at least a portion of a previously manufactured free-standing electrode film.

3. The method of claim 1, wherein said preparing the second mixture includes mixing the second mixture, and said subjecting the second mixture to the shear force includes mixing the second mixture with a greater shear force than during said preparing.

4. The method of claim 1, wherein the at least one electrode active material of the first mixture comprises one or more electrode active materials selected from the group consisting of lithium metal oxides, carbon-based materials, titanium dioxide, and silicon-based materials.

5. The method of claim 1, wherein the at least one electrode active material of the second mixture comprises one or more electrode active materials selected from the group consisting of lithium metal oxides, carbon-based materials, titanium dioxide, and silicon-based materials.

6. The method of claim 1, wherein either or both of the first and second mixtures further includes a conductive material.

7. The method of claim 1, wherein either or both of the first and second mixtures further includes a solvent.

8. The method of claim 7, wherein the solvent has a boiling point of less than 180° C.

9. The method of claim 1, wherein either or both of the first and second mixtures further includes a solid electrolyte powder.

10. The method of claim 1, wherein the shredded at least a portion of the first free-standing electrode film is 0.1% to 5% by weight of the second mixture.

11. The method of claim 1, wherein the shredded at least a portion of the first free-standing electrode film is 5% to 25% of the second mixture.

12. The method of claim 1, wherein the shredded at least a portion of the first free-standing electrode film is 25% to 50% of the second mixture.

13. The method of claim 1, wherein the shredded at least a portion of the first free-standing electrode film is 50% to 75% of the second mixture.

14. The method of claim 1, wherein the shredded at least a portion of the first free-standing electrode film is 75% to 95% of the second mixture.

15. The method of claim 1, wherein the shredded at least a portion of the first free-standing electrode film is greater than 95% of the second mixture.

16. A method of manufacturing an energy storage device, the method comprising:
the method of claim 1; and
laminating the second free-standing electrode film on a current collector.

17. A method of manufacturing a free-standing electrode film for an energy storage device, the method comprising:
preparing a first mixture including at least one electrode active material and at least one fibrillizable binder, the first mixture having total solid contents greater than 95% by weight;
fibrillizing the at least one fibrillizable binder in the first mixture by subjecting the first mixture to a shear force;
pressing the first mixture into a first free-standing electrode film;
shredding at least a portion of the first free-standing electrode film;
preparing a second mixture including the shredded at least a portion of the first free-standing electrode film;
subjecting the second mixture to a shear force; and
pressing the second mixture into a second free-standing electrode film.

18. The method of claim 17, wherein the first mixture includes at least a portion of a previously manufactured free-standing electrode film.

19. The method of claim 17, wherein the shredded at least a portion of the first free-standing electrode film is 100% of the second mixture.

20. The method of claim 17, wherein the shredded at least a portion of the first free-standing electrode film contains the only electrode active material that is included in the second mixture.

21. A method of manufacturing an energy storage device, the method comprising:
the method of claim 17; and
laminating the second free-standing electrode film on a current collector.

22. A free-standing electrode film for an energy storage device, the free-standing electrode film comprising:
at least one electrode active material; and
at least one fibrillizable binder,
wherein at least a portion of the at least one electrode active material and at least a portion of the at least one fibrillizable binder are recycled from a shredded electrode film.

23. The free-standing electrode film of claim 22, wherein total binder content of the free-standing electrode film is less than 8% by weight of the free-standing electrode film.

24. The free-standing electrode film of claim 22, wherein total binder content of the free-standing electrode film is less than 4% by weight of the free-standing electrode film.

25. The free-standing electrode film of claim 22, wherein total binder content of the free-standing electrode film is less than 3% by weight of the free-standing electrode film.
